(19) United States
(12) Patent Application Publication
(10) Pub. No.: US 2017/0328706 A1
(43) Pub. Date: Nov. 16, 2017

(54) MEASURING APPARATUS, ROBOT APPARATUS, ROBOT SYSTEM, MEASURING METHOD, CONTROL METHOD, AND ARTICLE MANUFACTURING METHOD

(71) Applicant: CANON KABUSHIKI KAISHA, Tokyo (JP)

(72) Inventors: Tsuyoshi Kitamura, Utsunomiya-shi (JP); Akihiro Yamada, Sakura-shi (JP)

(21) Appl. No.: 15/585,473

(22) Filed: May 3, 2017

(30) Foreign Application Priority Data
May 11, 2016 (JP) 2016-095109

(51) Int. Cl. G01B 11/27; G01B 11/14; G01K 11/00; G01K 11/12

(52) U.S. Cl. CPC G01B 11/272; G01K 11/125; G01B 11/14; G01K 11/006

(57) ABSTRACT

A measuring apparatus that performs measurement of position and posture of an object, the apparatus comprising: a measuring head for performing the measurement; a detector configured to detect a temperature; and a processor configured to output information of an offset amount of a position of the measuring head, based on the detected temperature.

### BACKGROUND OF THE INVENTION

### Field of the Invention

The present invention relates to a measuring apparatus, a robot apparatus, a robot system, a measuring method, a control method, and an article manufacturing method.

### Description of the Related Art

Machine vision is utilized for the measurement of position and posture for various processes, for example, grasping, assembling, and inspection of parts. In an apparatus used for the measurement, if a temperature inside a housing of the apparatus increases due to heat generation of a circuit substrate and an imaging element, a focusing position of an optical system arranged in the housing changes due to the expansion of a lens-barrel, the change of a refractive index of a glass material, and the like. Thereby, a measurement-enable region or measurement accuracy also changes. Japanese Patent No. 4858263 discloses a three-dimensional measuring apparatus including an imaging means in which a zoom and a focus can be changed, and correcting a change of camera information caused by differences in temperature based on temperature information from a temperature measurement means provided in an optical system and parameter information for each temperature of the imaging means. Japanese Patent Application Laid-Open No. H09-325019 discloses a three-dimensional measuring apparatus having a mode that performs measurement under fixed conditions and a mode that changes a measurement condition such as intensity of a detected light and a focusing state depending on a measurement environment (a state in a measurement region).

However, it is disadvantageous in the measuring apparatuses used in machine vision and the like that needs to be miniaturized to provide with a focusing function.

### SUMMARY OF THE INVENTION

The present invention provides, for example, a measuring apparatus advantageous in measuring precision and a size thereof.

A measuring apparatus that performs measurement of a position and a posture of an object, the apparatus comprising: a measuring head for performing the measurement; a detector configured to detect a temperature; and a processor configured to output information of an offset amount of a position of the measuring head, based on the detected temperature.

Further features of the present invention will become apparent from the following description of exemplary embodiments with reference to the attached drawings.

### BRIEF DESCRIPTION OF THE DRAWINGS

FIG. 1 illustrates a configuration of a machine vision system according to a first embodiment.

FIG. 2 illustrates a configuration of vision unit according to the first embodiment.

FIG. 3 illustrates an automatic assembling process according to the first embodiment.

FIG. 4 illustrates temperature dependence inside a housing with respect to a working distance.

FIG. 5 illustrates an automatic assembling process according to a second embodiment.

### DESCRIPTION OF THE EMBODIMENTS

### First Embodiment

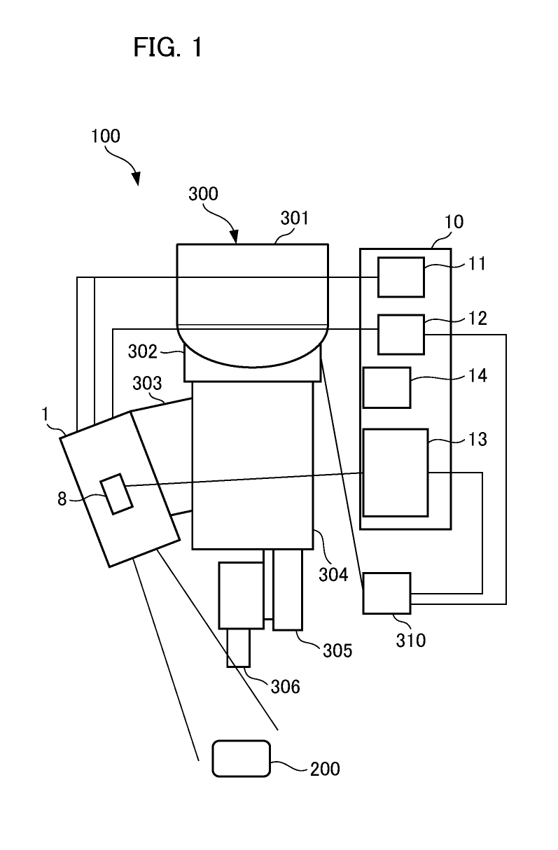

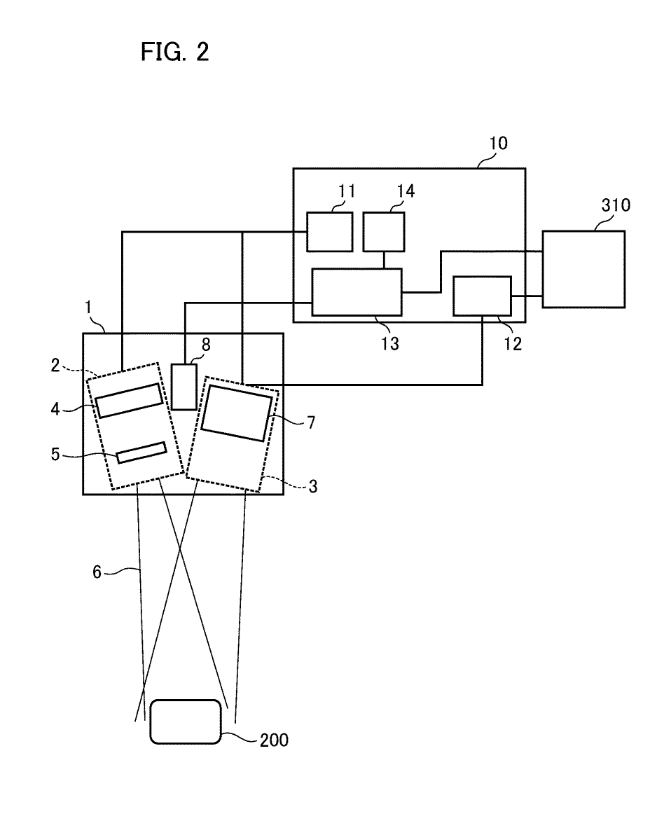

A description will be given of a function of each part of a robot system 100 in the present embodiment with reference to FIG. 1 and FIG. 2. The robot system 100 in the present embodiment assumes a system used for grasping and assembling parts. FIG. 1 illustrates a configuration of a machine vision system. As shown in FIG. 1, the robot system 100 includes a vision unit 1, a processing unit 10, a robot unit 300, a robot control unit (robot controller) 310, and performs a series of processes and operations such as recognition, grasping, and assembling of a work 200 by using them. In the present embodiment, the work 200 is indicative of, for example, an electronic part such as a connector and a capacitor (condenser) to be assembled to an electronic substrate, or indicative of the electronic substrate.

The processing unit 10 includes a control unit 11, a three-dimensional information calculation unit (hereinafter, referred to as a “three-dimensional information unit”) 12, a work measurement region calculation unit (hereinafter, referred to as a “processor”) 13, and a storage 14. The control unit 11 controls a projection device 2 and an imaging device 3. The three-dimensional information unit 12 acquires an image that has been imaged and calculates three-dimensional information of the work 200 based on this image. The vision unit position processor 13 acquires information about a temperature inside the vision unit and information about temperature dependence inside a housing with respect to the working distance, calculates a deviation amount of the working distance, and calculates an offset amount to be increased or decreased to a measurement region. The storage 14 stores the information about the temperature dependence inside the housing with respect to the working distance, which serves as information for acquiring the offset amount.

The robot unit 300 includes a robot arm (hereinafter, referred to as an “arm”) 301 that is a drive unit, a flange portion 302, a mounting portion 304, and a robot hand portion (hereinafter, referred to as a “hand portion”) 305. The arm 301 is driven such that a grasping part 306 is in proximity to the work 200 by an operation instruction provided from the robot control unit 310. The flange portion 302 is attached to the arm 301 and the mounting portion 304 is then fixed thereto. The mounting portion 304 is fixed to the flange portion 302, by which positional coordinates in a flange coordinate system that serves the flange as a reference are fixed. Additionally, the mounting portion 304 holds the vision unit 1 via an attaching stay 303. Accordingly, a relative relation between the vision unit 1 and the flange portion 302 is strictly defined. The hand portion 305 has the grasping part 306 at its end that grasps the work 200. The robot control unit 310 controls the robot unit 300 based on the three-dimensional information of the work 200 that has been calculated by the three-dimensional information unit 12.

FIG. 2 illustrates details of the vision unit 1 used in the first embodiment. The vision unit 1 is a measuring head that is loaded on the robot system 100 for performing the measurement of the three-dimensional shape of the work 200. The vision unit 1 is a three-dimensional shape measuring apparatus using the pattern projection method, and has the projection device (projection unit) 2 and the imaging device (imaging unit) 3. The projection device 2 and the imaging device 3 are contained in the same housing. The projection device 2 includes a light source 4 such as an LED, a pattern generation unit 5 for generating a pattern such as a pattern mask, and an illumination optical system and a projection optical system (not illustrated) configured by a lens and the like. The projection device 2 projects a pattern light 6 in accordance with an instruction provided from the control unit 11 included in the processing unit 10. As a pattern of the pattern light 6, for example, there is a stripe pattern in which bright lines and dark lines are alternately arranged. Additionally, there are various patterns such as a pattern in which any characteristic, for example, dot-like black points, are added on the bright lines in the stripe pattern for the distinguishing of the lines, or a pattern in which dot-like lights are randomly arranged. The pattern light 6 is irradiated to the work 200. The work 200 to which the pattern light 6 has been irradiated is imaged by the imaging device 3 in accordance with an instruction provided from the control unit 11.

The imaging device 3 includes an imaging optical system (not illustrated) configured by, for example, an imaging device 7 such as a CCD and a CMOS, and a lens. An imaging unit images the work 200 onto which the pattern light 6 has been irradiated in accordance with the instruction provided from the control unit 11. An image captured by the imaging device 7 is transmitted to the three-dimensional information unit 12 in the processing unit 10. The three-dimensional information unit 12 calculates the three-dimensional information for the work 200 based on this image that has been imaged.

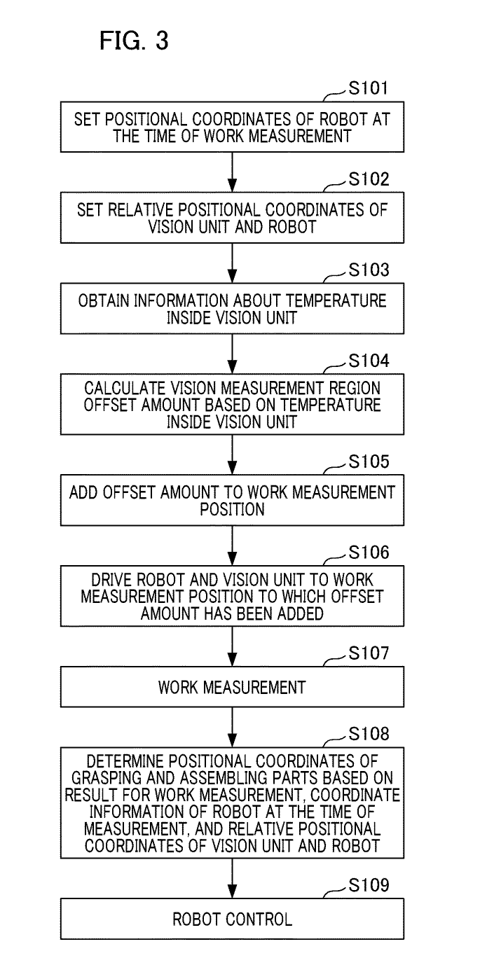

Next, a description will be given of an automatic assembling process in a typical robot system by using a part of the assembling process shown in FIG. 3. For performing the grasping and the assembling, first, it is necessary to acquire the three-dimensional information for the work 200 to be a target. If the three-dimensional information measurement of the work 200 is performed, the robot unit 300 is controlled and driven such that the work 200 is present in a measurement-enabled range of the vision unit 1. Accordingly, in the automatic assembling process, a step (S101) that sets the positional coordinates of the robot at the time of work measurement and a step (S102) that sets relative positional coordinates of the vision unit and the robot are needed.

The positional coordinates of the robot in step S101 is indicative of positional coordinate information about where the robot should wait in order for the work 200 to move to the measurement region of the vision unit 1 at the time of the measurement of the work 200. Specifically, the positional coordinates of a flange portion 302 of the robot in the world coordinate system at the time of the measurement of the work (a coordinate system in which three axes orthogonal to each other at the origin are the x-axis, the y-axis, and the z-axis, where one point in a real space serves as the origin). The relative relation between the flange portion 302 and the vision unit 1 is strictly defined, so that the correct setting of the positional coordinates of the flange portion 302 enables the setting such that the work 200 is contained within the measurement region of the vision unit 1. In step S102, the relative positional coordinates of the vision unit 1 and the flange portion 302 that serve as a coordinate reference of the robot are set. A setting value of the relative positional coordinates is acquired by acquisition of the relative position and posture of the vision unit in the flange coordinate system of the flange portion 302 by pre-calibration and the like.

The robot control unit 310 controls the robot unit 300 based on the positional coordinate information set in step S101, and moves the vision unit 1 to a position where the measurement of the work 200 is possible. Subsequently, in the vision coordinate system of the vision unit 1 after the move (the coordinate system that serves a vision sensor as a reference), the robot control unit 310 acquires information about position and posture of the work 200 (S107). Here, it is possible to derive the positional coordinate information of the vision unit in the world coordinate system, based on the positional coordinate information of the flange portion 302 in the world coordinate system acquired in step S101, and the relative positional coordinates of the vision unit in the flange coordinate system acquired in step S102. Consequently, it is possible to acquire the information about the position and posture of the work 200 in the world coordinate system, based on the information about the positional coordinates of the vision unit in the world coordinate system and the information about the position and posture of the work 200 in the vision coordinate system acquired in step S107.

The robot control unit 310 calculates the information about the position and posture of the grasping part and the assembling part in the work 200 set in advance, based on the information about the position and posture of the work 200 in the world coordinate system (S108). Then, the robot control unit 310 sets the coordinates of the flange portion 302 such that the grasping part 306 operates at the position, and performs the control and the drive of the robot. Subsequently, the robot control unit 310 performs various operations including the grasping and assembling, which are purpose of the robot system (S109). The above is the automatic assembling process in the typical robot system. In the above steps, the position of the vision unit 1 with respect to the work 200 at the time of the measurement of the work 200 is uniquely determined through steps S101 and S102.

However, in the vision unit 1, a temperature inside the housing changes depending on the production to be used and an environment of a processing site. Hence, a focal length of the optical system changes and thereby the working distance of the vision unit 1 also changes. Accordingly, at the time of the measurement of the work 200, coordinates to be taken by the vision unit 1 with respect to the work 200 change depending on the temperature environment. It is impossible for the above typical robot system to respond to the change, differences are caused in the measurement accuracy in response to the temperature even if the work present in the same place is measured, and as a result, a large deviation is caused in a region where the accuracy can be guaranteed.

Accordingly, a description will be given of the automatic assembling process in the case of applying the present embodiment, based on the automatic assembling process shown in FIG. 3 and the configuration of the robot system 100 shown in FIG. 1. First, steps S101 and 102 are necessary even in the automatic assembling process of the present embodiment and are performed in a manner similar to the conventional automatic assembling processes. In step S101, the positional coordinates of the robot at the time of the measurement of the work, in other words, the positional coordinates of the flange portion 302 in the world coordinate system, are set. In step S102, the relative positional coordinates of the vision unit and the robot, in other words, the relative positional coordinates of the vision unit in the flange coordinate system, are set.

Next, in the present embodiment, the information about the temperature inside the vision unit is acquired in step S103. This is performed by a temperature detection unit (detector) 8 provided in the vision unit 1 shown in FIG. 2. A small thermocouple is illustrated as an example of the temperature detection unit 8, and the internal temperature of the vision unit is acquired by using this small thermocouple unit. Since the temperature detection unit 8 here is very small, the addition of the temperature detection unit 8 has almost no influence on the size of the measuring apparatus.

Subsequently, a vision measurement region offset amount is determined in step S104 based on the temperature inside the vision that is a detected result acquired in step S103, and the offset amount is added to the work measurement position in step S105. These are performed in the vision unit position processor 13 provided in the processing unit 10 shown in FIG. 1 and FIG. 2. First, a description will be given of details of step S104. In step S104, the vision unit position processor 13 receives the information about the temperature inside the vision unit acquired by the temperature detection unit 8 and the information about the temperature dependence inside the housing with respect to the working distance stored in the storage 14. This dependence information indicates how the focal position (best focal position) of the imaging device 3, in other words, the working distance, changes with respect to the change of the focal length of the optical system due to the temperature inside the housing. In the present embodiment, this dependence information is acquired in advance before the operations such as work recognition and assembling in the robot system 100. This advance acquisition of the information may be realized by measuring the relation between the temperature inside the vision unit and the measurement-enable range of the vision unit, or may be realized by calculation in advance by using, for example, the temperature inside the vision unit, an expansion coefficient of a lens-barrel of the optical system, and dn/dT of a glass material.

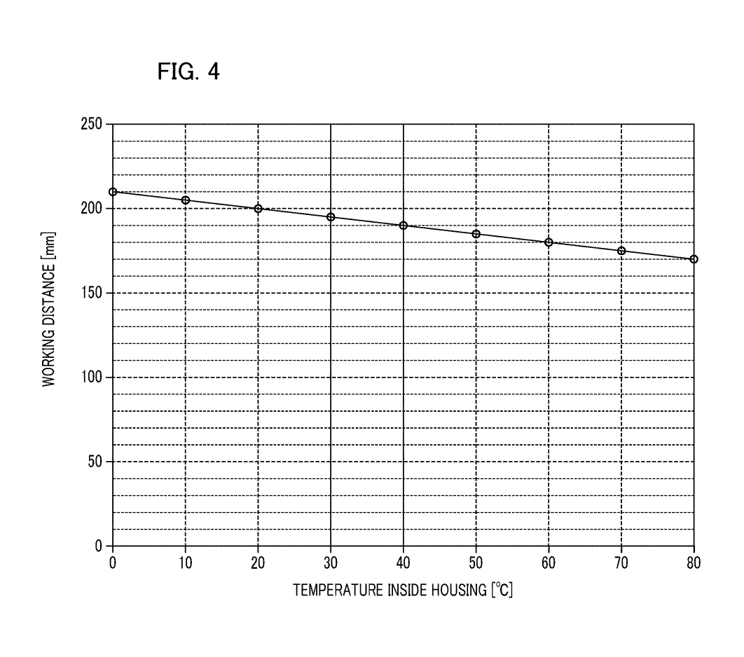

FIG. 4 illustrates one example with regard to the temperature dependence inside the housing with respect to the working distance. In FIG. 4, as the value of the working distance is larger, the measurement position is closer to the work 200. For example, in a case where the temperature inside the housing being 20° C. is set as the reference temperature, if the measurement in which the temperature inside the housing being 10° C. is performed, the measurement-enable region (measurement position) deviates 10 mm toward the work 200 from the measurement position with the reference temperature.

In contrast, if the measurement of the temperature inside the housing is performed at 30° C., the measurement region (measurement position) deviates 10 mm toward the vision unit 1 from the measurement position of the reference temperature. This deviation amount of the measurement region (measurement position) needs to be taken into account in the next or subsequent process to serve as the offset amount of the vision measurement region caused by the change of the temperature.

Next, a description will be given of details of step S105. In step S105, the vision unit position processor 13 adds the offset amount to the work measurement position and calculates the positional coordinates of the flange portion 302 in the world coordinate system at the time of the measurement of the work 200 to which the temperature change amount has been considered. Specifically, the offset amount in the vision measurement region determined in step S104 is added with respect to the positional coordinates of the flange portion 302 in the world coordinate system at the time of the work measurement set in step S101. Note that it may be possible to output the offset amount that has been calculated in step S104 to the robot control unit 310 from the vision unit position processor 13 and calculate the positional coordinates of step S105 in the robot control unit 310.

Subsequently, in step S106, the robot is moved to the work measurement position to which the offset amount calculated in step S105 has been added. Specifically, the positional coordinates of the flange portion 302 in the world coordinate system taking into account the offset amount determined in step S105 is output to the robot control unit 310 from the vision unit position processor 13. Subsequently, the robot control unit 310 controls and drives the arm 301 of the robot based on the received positional information so as to move the vision unit 1 and each part of the robot to the measurement position. Hence, the information output to the robot control unit 310 from the vision unit position processor 13 is one of the offset amounts itself calculated in step S104 and the positional coordinates of the flange portion 302 in the world coordinate system to which the temperature change amount calculated based on the offset amount has been considered. The information on the offset amount itself and the information about the positional coordinates of the flange portion 302 in the world coordinate system at the time of the measurement of the work 200 to which the temperature change amount calculated based on the offset amount has been considered collectively served as information related to the offset amount.

Next, in step S107, the measurement of the work 200 is performed. The addition of the offset amount to the measurement position as described above consequently has almost no influence on the change of the focal length due to the change in temperature inside the housing with respect to the measurement result of the work 200 to be measured. Specifically, the work 200 is contained within the measurement accuracy guarantee region irrespective of the change in temperature inside the housing. Note that although the change of the measurement value also occurs not only due to the change of the working distance caused by the change in temperature, but also due to the change of the focal length, the positioning deviation of the optical system, and the like, and these are separately corrected. In the measurement, it is possible to acquire the information about the position and posture of the work 200 with respect to the positional coordinates of the vision unit 1 to which the offset amount has been added.

Next, in step S108, the three-dimensional information unit 12 determines the positional coordinates of the grasping and assembling of the parts, based on the result for the measurement of the work acquired in step S107, the information about the coordinates of the robot at the time of the measurement acquired in step S105, and the relative position and posture of the vision unit and the robot acquired in step S102. Here, it is possible to determine the information about the position and posture of the vision unit taking into account the offset amount in the world coordinate system, based on the positional coordinates of the flange portion 302 in the world coordinate system taking into account the offset amount acquired in step S105 and the relative position and posture of the vision unit in the flange coordinate system acquired in step S102. Accordingly, it is possible to acquire the information about the position and posture of the work 200 seen from the world coordinate system based on the information about the position and posture of the vision unit taking into account the offset amount in the world coordinate system and the information about the position and posture of the work 200 with respect to the positional coordinates of the vision unit 1 to which the offset amount determined in step S107 has been added. The information about the position and posture of the work 200 seen from the world coordinate system here is correctly indicative of the position and posture of the work 200, not depending on the offset amount added in step S106.

In step S109, in a manner similar to the conventional apparatus described above, the control and drive of the robot are performed based on the information about the position and posture of this work 200 and the operations such as grasping and assembling are performed. The information about the position and posture of the work 200 seen from the world coordinate system calculated in step S108 is transmitted to the robot control unit 310 from the three-dimensional information unit 12, and the robot control unit 310 controls the movement of the robot based on the information about the position and posture of the work 200.

As described above, in the assembling process of the present embodiment, the deviation amount of the measurement region to which the temperature of the housing is reflected is taken into account to serve as an offset amount and the measurement of the work 200 is performed by using the measurement coordinates to which the offset amount has been considered. Accordingly, it is possible to measure the work 200 without the influence of the temperature inside the housing. Additionally, the three-dimensional measuring apparatus responds to the change in temperature only by adding the extremely small temperature detection unit 8 and adding a function for the processing unit 10, without increasing the size of the apparatus by adding, for example, a focus lens as a measure for the change in temperature as described in some prior arts. Specifically, it is possible to provide the three-dimensional measuring apparatus with a simple configuration, which realizes work recognition with a high accuracy, even if a focal point of the optical system of the three-dimensional measurement system changes due to the change in the temperature and then the measurement-enable region changes.

### Second Embodiment

In the first embodiment, the description was given of the measure for the change in a focal length in response to the temperature inside the housing. However, from the viewpoint that this is a change of a proper measurement position due to the influence of the temperature, the influence of the expansion of the robot due to the environment temperature is also conceivable. If the robot is deformed, the measurement position of the vision unit at which the relative relation with the robot is determined changes, so that the working distance changes. In contrast, in the present embodiment, the environment temperature is acquired, and the measure is performed for the change affected on the working distance caused by the change.

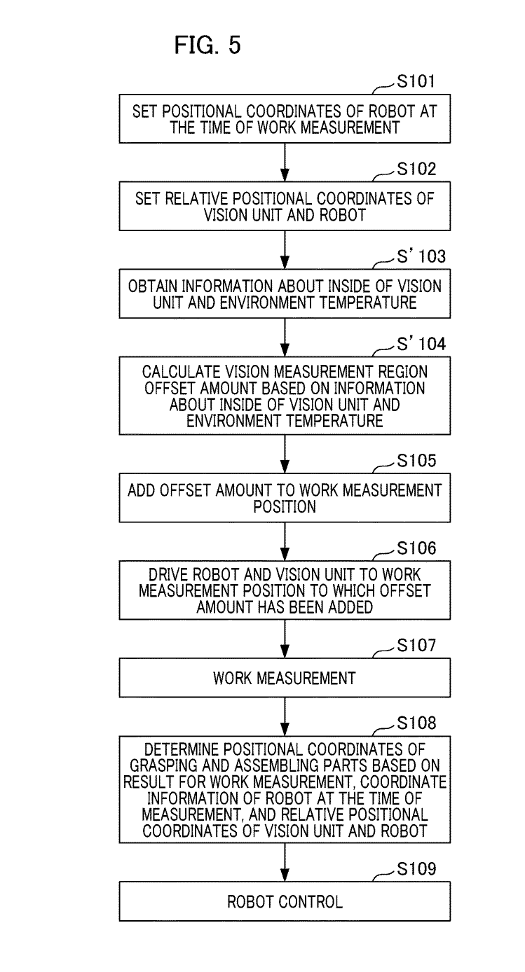

FIG. 5 illustrates an automatic assembling process in the second embodiment. The differences between automatic assembly process in the second embodiment and the automatic assembling process in the first embodiment shown in FIG. 3 are steps S′103 and S′104. In S′103, in addition to the temperature inside the housing, the environment temperature that is a temperature outside the housing is measured. This measurement is performed by a temperature detection acquiring unit additionally provided outside the housing. The environment temperature is a temperature that also affects the measurement position of the vision unit resulting from an influence of the measurement position of the vision unit due to the change of the temperature. The temperature detection acquiring unit that has been added detects the environment temperature by measuring an ambient temperature of the robot, a temperature of the robot itself, and an ambient temperature of the vision unit loaded on the robot. The environment temperature that has been acquired is transmitted to the vision unit position processor 13. In S′104, the vision unit position processor 13 calculates not only the change of the working distance in response to the temperature inside the housing in the calculation of the measurement region shown in the first embodiment, but also a deformation amount of the robot in response to the environment temperature, and determines the offset amount to be increased or decreased in the measurement region by adding the deformation amount. Other steps are similar to those in the first embodiment. According to the present embodiment, it is possible to provide the three-dimensional measuring apparatus that enables the measurement also reflecting the change of the focal point caused by not only the change in temperature inside the housing, but also the change in the environment temperature, and consequently realizes the work recognition with a high accuracy.

### Third Embodiment

In the first embodiment, the information about the temperature dependence inside the housing with respect to the working distance stored in the storage 14 is stored. Although this is determined by acquiring and calculating data in advance, the working distance is calculated without such a preparation in advance in the present embodiment. In the present embodiment, parameter information such as an expansion coefficient of the lens-barrel of the optical system and dn/dT of the glass material that is necessary for the calculation of the working distance is stored in the storage 14 to serve as information for acquiring an offset amount. The vision unit position processor 13 calculates a change amount of the working distance based on the information about the temperature inside the vision unit acquired by the temperature detection unit 8 and the parameter information. The vision unit position processor 13 determines an offset amount to be increased or decreased in the measurement region based on this change amount. The other steps are similar to those in the first embodiment. In the present embodiment, it is unnecessary to acquire and calculate data in advance. Of course, although a calculation time is required, frequent corrections are not needed in a case where the temperature is relatively stable. In that case, a serious adverse effect is not thereby brought to a throughput of the apparatus.

In each embodiment described above, although the steps of S101 and S102 are shown in an order for explanation, the order of these steps can be in any particular order. The summary of each embodiment is to acquire the temperature, calculate the change of the working distance, and reflect it to the measurement position at the timing prior to the measurement of the work 200. It is obvious that the order of each step may change within the range that satisfies this summary. Additionally, in the above examples, although the measuring apparatus using the pattern projection method with regard to the vision unit 1 that is a three-dimensional information measuring apparatus has been exemplified, the present invention is not limited to this. The present invention may apply any other measuring methods including a stereo measurement method. Regardless of the measurement methods, each embodiment is applied to the three-dimensional information measuring apparatus having an optical system and causing a change of the measurement range in response to the temperature. Additionally, in FIG. 1 and FIG. 2, although the processing apparatus that controls the three-dimensional information measuring apparatus and calculates the three-dimensional information, and the robot control unit are separately illustrated, they may be consolidated together in one apparatus. The requirement of the present embodiment is to have the vision unit position processor 13 and the temperature detection unit 8 as described above and act as each function, and there are no particular limitations on the state in which they exist.

### (Embodiment According to an Article Manufacturing Method)

The measuring apparatus according to the embodiments described above is used in an article manufacturing method. The article manufacturing method includes a process of measuring an object using the measuring apparatus, and a process of processing the object on which measuring is performed in the process. The processing includes, for example, at least one of machining, cutting, transporting, assembly, inspection, and sorting. The article manufacturing method of the embodiment is advantageous in at least one of performance, quality, productivity, and production costs of articles, compared to a conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-095109 filed on May 11, 2016, which is hereby incorporated by reference herein in its entirety.

What is claimed is:

1. A measuring apparatus that performs measurement of a position and a posture of an object, the apparatus comprising:
a measuring head for performing the measurement;
a detector configured to detect a temperature; and
a processor configured to output information of an offset amount of a position of the measuring head, based on the detected temperature.

2. The measuring apparatus according to claim 1 further comprising:
a projection device configured to project a pattern onto the object;
an imaging device configured to image the object onto which the pattern is projected; and
a housing that contains the projection device and the imaging device,
wherein the detector is configured to detect a temperature inside the housing.

3. The measuring apparatus according to claim 2, further comprising: another detector configured to detect a temperature outside the housing.

4. The measuring apparatus according to claim 1 further comprising a storage configured to store information for obtaining the offset amount corresponding to the detected temperature,
wherein the processor is configured to obtain the offset amount based on the detected temperature and the stored information.

5. A robot apparatus comprising:
a robot configured to hold and move a measuring head included in a measuring apparatus defined in claim 1; and
a controller configured to perform control of movement of the robot based on information of the offset amount received from the measuring apparatus.

6. A system comprising:
a measuring apparatus defined in claim 1;
a robot apparatus including a robot configured to hold and move a measuring head included in the measuring apparatus, and a controller configured to perform control of movement of the robot based on information of the offset amount received from the measuring apparatus.

7. A measuring method of performing measurement of a position and a posture of an object, the method comprising steps of:
detecting a temperature; and
obtaining information of an offset amount of a position of a measuring head for performing the measurement, based on the detected temperature.

8. A control method of performing control of movement of a robot via performing measurement of a position and a posture of an object using a measuring head held and moved by the robot, the method comprising steps of:
detecting a temperature;
obtaining information of an offset amount of a position of the measuring head, based on the detected temperature; and
performing the control based on the obtained information.

9. A method of manufacturing an article, the method comprising steps of:
performing measurement of an object using a measuring apparatus defined in claim 1; and
processing the object, of which the measurement has been performed, to manufacture the article.

10. A method of manufacturing an article, the method comprising steps of:
performing measurement of an object using a measuring method defined in claim 7; and
processing the object, of which the measurement has been performed, to manufacture the article.

11. A method of manufacturing an article, the method comprising steps of:
performing control of movement of an object using a control method defined in claim 8; and
processing the object, of which the control has been performed, to manufacture the article.
